(19) United States
(12) Patent Application Publication
(10) Pub. No.: US 2005/0005394 A1
(43) Pub. Date: Jan. 13, 2005

(54) Swivel caster

(76) Inventors: Alon Adam, Ville Saint-Laurent (CA); Shai Adam, Ville Saint-Laurent (CA)

Correspondence Address: JACK PAAVILA, BOX 1151, ALEXANDRIA, KOC IA0, CA

(21) Appl. No.: 10/612,948

(22) Filed: Jul. 7, 2003

(51) Int. Cl. B60B 33/00

(52) U.S. Cl. 16/18 R

(57) ABSTRACT

A swivel caster having a top mounting member for attachment to the bottom of a vehicle and a bottom caster member having a caster wheel support extending downwardly therefrom with a caster wheel at the free end thereof. The bottom member has a stub shaft extending toward the top member, the top member having a circular bore for receiving the free end of the stub shaft and a counterbore concentric about the bore. A stock thrust ball bearing is press fit mounted in the counterbore about the stub shaft, the thrust ball bearing mounted to transfer load from the top member to the bottom member. The caster has a second bearing means comprising a ring of loose balls mounted in an annular raceway, with part of the raceway formed in the circular wall defining the bore and part of the raceway formed in the stub shaft. The second bearing means permits rotation of the bottom member relative to the top member and also retains the stub shaft in the circular bore to connect the top and bottom members together.

### BACKGROUND OF THE INVENTION

1. Field of the Invention

This invention is directed toward a swivel caster without a kingpin. The invention is more particularly directed toward a two-member swivel caster without a kingpin having a first stock bearing for taking a thrust load and a second bearing means employing loose balls permitting swiveling, the loose balls also holding the caster members together.

2. Description of the Related Art

Swivel casters are employed to rotatably mount wheels on the bottom of a platform of a vehicle. The casters generally employ a first support member mounted on the bottom of the platform of the vehicle and a second caster member, carrying the caster wheel, rotatably mounted on the first member for rotation about a vertical axis. A kingpin usually rotatably connects the bottom member to the top member. At least one set of bearing means is mounted between the top and bottom members about the kingpin for allowing the bottom member to easily rotate or swivel relative to the top member. A second set of bearing means can be mounted between the top and bottom members about the kingpin, separate from the first set, to help transfer the load from the platform to the caster wheel. The bearing means employed are usually loose balls in raceways. Examples of casters employing kingpins and one or two sets of bearing means are shown in U.S. Pat. Nos. 1,838,678; 3,127,633 and 5,461,753

It is known to employ casters without a kingpin. Such casters usually employ a stub shaft on the bottom caster member inserted into a bore in the top support member, the stub shaft replacing the kingpin. The use of a stub shaft in place of a king pin can reduce the overall height of the caster and the stub shaft can also be thicker than a king pin making the caster stronger. Retaining means are provided for holding the stub shaft within the bore to connect the top and bottom members together. At least one set of bearing-means is mounted between the top and bottom members about the stub shaft for allowing the bottom member to easily rotate or swivel relative to the top member. The bearing means can have an annular raceway formed in part in the stub shaft and in part in the top support member with bearing balls freely filling the raceway. This construction allows the bearing means to also form the retaining means. In simple casters only one bearing means is usually employed. An example is shown in U.S. Pat. Nos. 1,421,626 (FIG. 3) and 3,606,503.

In more complicated casters using a stub shaft, two sets of bearing means can be employed, with one bearing means providing pivoting or swiveling and the other bearing means transferring the load. One of the bearing means, usually the swivel bearing means, also usually connects the top and bottom members together. The first and second sets of bearing means employ loose bearing balls inserted into raceways formed between the top and bottom members. Examples are shown in U.S. Pat. Nos. 1,421,626 (FIG. 2) and 5,983,451

The disadvantage of using bearing means with loose balls is that assembly of the caster takes time while the balls are inserted into the raceways and closure means are provided preventing egress of the balls, particularly in casters employing two sets of bearing means. Also, the loose balls, in providing rotation and transmitting load while being relatively loose in the raceway wear quickly causing the caster assembly to become loose and leading to failure more quickly. The balls are relatively loose in the raceways since large manufacturing tolerances are needed to allow loading of the balls into the raceways. The balls, and the raceways carrying the balls, can be hardened by heat treatment to prolong their life, but this adds cost to the making of the casters.

It is known to use a stock ball bearing alone mounted between the members to allow the bottom member, carrying a stub shaft, to rotate about the top support member. By a stock ball bearing it is meant a bearing that can be bought ready for use. A stock bearing such as a ball bearing has the balls already contained between bearing races. Retainer means in the form of a clip hold the stub shaft in place within the top support member. An example is shown in U.S. Pat. No. 3,015,838.

The use of a stock ball bearing alone has several advantages over a bearing means using loose balls. The balls in a stock bearing are already hardened. Further, the balls are already held in place by the bearing races. Thus the balls turn together without touching and there is not much wear. When using loose balls, the balls touch when turning and wear out more quickly than the balls in a stock bearing. Mounting of the stock bearing is simple and quick making assembly of the caster faster and cheaper. However the stock bearing alone cannot handle large loads, particularly thrust loads, together with swiveling, so the use of the arrangement is limited. Also the retainer means needed requires easy access and this access can allow dirt to enter the stock bearing.

It has been found that a kingpin-less caster using a single stock bearing is considerably improved using a second bearing means in the form of loose balls in a raceway. The loose balls are mounted between the stub shaft on one of the members and the other member in a raceway common to both the stub shaft and the other member. Thus the second bearing means also act as retaining means so that the clip retaining means can be dispensed with. The second bearing means also handles the swiveling of the caster. The second bearing means also takes some of the thrust load thereby increasing the life of the stock bearing and allowing the caster to handle bigger loads. With the balls employed normally about the stub shaft, and the stub shaft having a relatively small diameter, not too many balls are required and not too much time is required to load them. The balls can be used without hardening they take only a small proportion of the thrust load and, since even if these loose balls wear, the stock bearing still provides a tight fit between the caster members.

### SUMMARY OF THE INVENTION

It is the purpose of the present invention to provide a swivel caster without a kingpin that is stronger and longer lasting than the known swivel casters without kingpins. It is also the purpose of the present invention to provide a caster without a kingpin that is easier and simpler to manufacture and thus cheaper.

In accordance with the present invention, a caster is provided without a king pin that employs as one of the bearing means, and as the load bearing means particularly, a standard or stock bearing. By a ‘stock’ bearing it is meant a standard bearing that can be purchased complete from manufacturers, the bearing ready for installation and use, and requiring no assembly by the user. The second bearing means, providing swiveling, can comprise loose bearing balls mounted in a common raceway formed between the top and bottom members. The bearing balls in the raceway in the second bearing means, besides providing swiveling, also serve to join the top and bottom caster members together. The second bearing means also helps to transfer some of the load between the members thus increasing the life of the standard bearing.

The use of a stock bearing provides a precise, close tolerance fit. The ball bearings in the unit, and usually the raceways holding them, have already been hardened so no heat treatment is necessary. Since stock bearings are normally made to close tolerances the standard bearing can transfer more load and has a much longer life. The stock bearing also speeds assembly of the caster unit since only one bearing unit has to be mounted to install one bearing means. The stock bearing is preferably a thrust ball bearing but it could also be other types of bearings such as, for example, angular contact ball bearings; self aligning ball bearings; deep groove ball bearings; tapered roller bearings or cylindrical roller bearings.

The invention is particularly directed toward a kingpin-less swivel caster having a top mounting member for attachment to the bottom of a vehicle and a bottom caster member having a caster wheel support extending downwardly therefrom with a caster wheel at the free end thereof. One of the top and bottom members has a stub shaft extending toward the other member, the other member having a circular bore for receiving the free end of the stub shaft and a counterbore concentric about the bore. A first bearing means comprising a stock bearing is press fit mounted in one of the bore and the counterbore about the stub shaft, the first bearing means mounted to transfer load from the top member to the bottom member. A second bearing means comprising a ring of loose balls mounted in a two-part annular raceway, is provided with one part of the raceway formed in the circular wall defining the other of the bore and the counterbore, the second bearing means permitting rotation of the bottom member relative to the top member and retaining the stub shaft in the circular bore to connect the members together.

### BRIEF DESCRIPTION OF THE DRAWINGS

FIG. 1 is a cross-section view of the preferred swivel caster with the stock bearing below the second bearing means;

FIG. 2 is an exploded view of the swivel caster shown in FIG. 1;

FIG. 3 is a cross-section view of a swivel caster with the stock bearing above the second bearing means;

FIG. 4 is a cross-section view of a modification of the swivel caster with the stub shaft mounted on the top mounting member and the stock bearing below the second bearing means; and

FIG. 5 is a cross-section view similar to FIG. 4 but with the stock bearing above the second bearing means.

### DESCRIPTION OF THE PREFERRED EMBODIMENTS

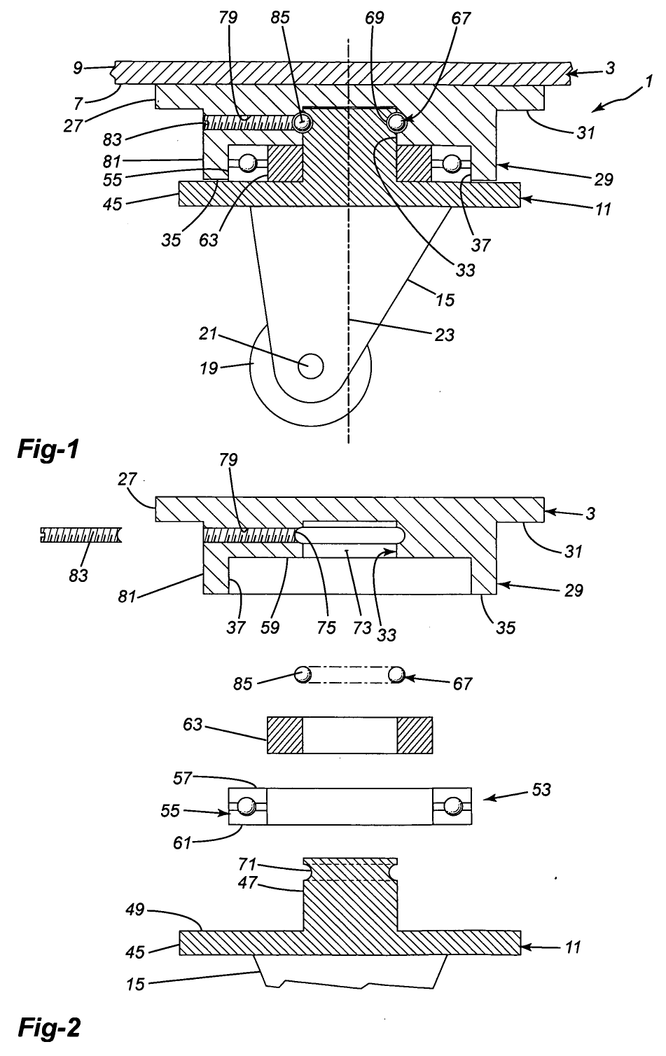

The swivel caster 1 of the present invention, in its preferred embodiment as shown in FIGS. 1 and 2, has a top mounting member 3 which is adapted to be mounted, by suitable means, not shown, onto th bottom 7 of a platform 9 of a vehicle. The caster 1 also has a bottom caster member 11 which has a caster wheel support 15 carrying a caster wheel 19. The caster wheel 19 is rotatably mounted at the free end of the caster wheel support 15, the caster wheel 19 rotatable about a horizontal axis 21 which axis is horizontally spaced from vertical axis 23 of rotation of the caster wheel support 15 as is well known in the swivel caster art.

It should be mentioned now that the terms ‘top’ and ‘bottom’ as used in this application are applied in describing the assembled caster when in its normal working position mounted on the bottom of a vehicle.

The top mounting member 3 has a top plate 27 which carries a top mounting block 29 on its bottom surface 31. The mounting block 29 is preferably integral with the top plate 27. The top mounting block 29 is in the shape of a short cylinder and has a central bore 33 extending upwardly from the bottom 35 of the block 29 and a shorter counterbore 37, concentric about the bore 33, also extending upwardly from the bottom 35 of the block 29.

The bottom caster member 11 has a bottom plate 45 with a stub shaft 47 extending upwardly from about the center of the top surface 49 of the bottom plate 45, the longitudinal axis of the stub shaft 47 forming the vertical axis 23 of rotation of the caster wheel support 15.

The caster 1 also includes first bearing means 53 in the form of a stock bearing 55 mounted between the top and bottom mounting members 3, 11. The stock bearing 55 is preferably a thrust ball bearing and is sized to press fit snugly within the counterbore 37 in the block 29. When mounted within the counterbore 37, the top 57 of the bearing 55 abuts the bottom 59 of the counterbore 33 in the top mounting block 29 and the bottom 61 of the bearing 55 abuts the top 49 of the bottom plate 45 in the bottom caster member 11. The bearing 55 is sized in height to have the top 49 of the bottom plate 45 spaced slightly from the bottom 35 of the block 29, the bearing 55 acting as a thrust bearing transferring load from the top member 3 to the bottom member 11. The bearing 55 can be sized to have the stub shaft 47 pass snugly though it. Preferably however, to handle larger loading, the bearing 55 can be considerably larger in diameter than the stub shaft 47, as shown. In this case, and, if desired though not essential, a spacer ring 63 can be snugly mounted between the stub shaft 47 and the stock bearing 55

Second bearing means 67 are provided between the stub shaft 47 and the top mounting block 29. The second bearing means 67 has a two-part annular raceway 69 formed with one part in the stub shaft 47 as shown by the circular groove 71 and with the other part in the block 29, and more particularly in the circular wall 73 defining the bore 33, as shown by the circular groove 75. Both grooves 71, 75 are semicircular when seen in transverse cross-section, as shown in FIG. 2 with the dividing line between the grooves being vertical. The two grooves can be formed, if desired, in a offset manner as is well known where the dividing line between the grooves is angled slightly from the vertical.

When the stub shaft 47 is snugly inserted into the bore 33, the grooves 71, 75 align forming the annular raceway 69. A radial passageway 79 extends through the block 29 from its outer surface 81 to intercept the groove 71. The passageway 79 can be closed by plug 83 or the like. Loose bearing balls 85 are inserted into the raceway 69, formed when the stub shaft 47 is inserted into the bore 33, through passageway 79 to fill the raceway. The bearing balls 85 in the raceway 69 form the second bearing means 67. These second bearing means 67 facilitate rotation, or swiveling, of the bottom caster member 11 relative to the top mounting member 3. These second bearing means 67 also act as retainer means retaining the stub shaft 47 within the block 29 and thus connecting the top and bottom members 3, 11 together. The second bearing means 67 can also take some of the thrust loading off the first bearing means 53 thereby extending its life.

The first and second bearing means are quickly and easily installed. The stock bearing 55 is a complete bearing unit and the counterbore 37 is machined to receive it in press-fit fashion making it easy to install. With the loose balls 85 of the second bearing means 67 encircling the relatively small-diameter stub shaft 47, not many are needed and the loading of the balls 85 into the raceway 69 does not take too much time during assembly of the caster.

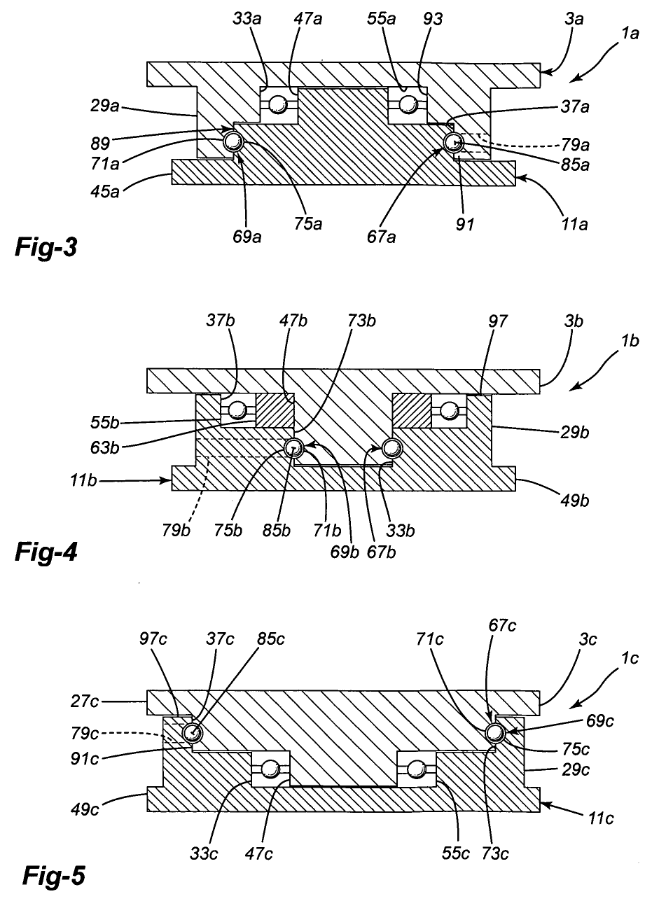

While the swivel caster 1 has been described with the stock bearing 55 beneath the second bearing means 67, the caster 1a can be modified to have the stock bearing 55a above the second bearing means 67a. As shown in FIG. 3, the bottom caster member 11a is formed with a circular step 89 on the bottom plate 45a, the step 89 fitting snugly within the counterbore 37a in the top mounting member 3a. The raceway 69a is formed between a first groove 71a formed in block 29a the wall of the counterbore 37a and a second groove 75a formed in the circular wall 91 of the step 89. A radial passageway 79a extends between the outer surface of the block 29a and the groove 71a. Loose balls 85a are inserted in the raceway 69a formed when the stub shaft 47a is inserted into the bore 33a. The bore 33a is now larger forming a space for the stock bearing 55a between the stub shaft 47a and the circular wall 93 of the bore 33a. The bore 33a is not quite as deep as the bearing 55a so load is transferred from the top member 3a to the bottom member 11a. This caster is not as easy to assemble as the first caster described since the stock bearing 55a used may be smaller in diameter and since the second bearing means 69a is larger in diameter requiring more balls 85a and thus more time to load them in assembling the caster. However this caster can work satisfactorily.

In another embodiment of the invention, the caster can be provided with the stub shaft on the top mounting member instead of on the bottom caster member as shown in FIGS. 1 and 3. In this embodiment, the bore and counterbore are provided on the bottom caster member. As shown in FIG. 4, the top mounting member 3b of the caster 1b has a top plate with a stub shaft 47b extending downwardly therefrom. The bottom caster member 11b has a bottom plate 49b with a circular block 29b thereon. A bore 33b is provided in the block 29b extending downwardly from its top surface 97. A counterbore 37b extends downwardly from the top surface 97 concentric about the bore 33b. A stock bearing 55b is press-fit mounted within the counterbore 37b about the stub shaft 47b. The bearing 55b is slightly higher than the depth of the counterbore 37b allowing load to be transferred from the top mounting member 3b to the bottom caster member 11b. A spacer ring 63b is provided about the stub shaft 47b between the shaft and the stock bearing 55b.

Second bearing means 67b are provided between the stub shaft 47b and the block 29b. The second bearing means 67b has an annular raceway 69b formed in two parts, one part being an annular groove 71b in stub shaft 47b and the other part being an annular groove 75b in the inner wall 73b forming the bore 33b. The grooves 71b, 75b are semi-circular when seen in cross-section. When the stub shaft 47b is inserted into the bore 33b, the grooves 71b, 75b align forming the raceway 69b. Loose bearing balls 85b are inserted into the raceway 69b through a passageway 79b in the block 29b. The second bearing means 67b facilitate rotation of the bottom caster member 11b relative to the top mounting member 3b and also serve to retain the stub shaft 47b within the bore 33b thereby connecting the two members 3b, 11b together.

In another embodiment, with the stub shaft on the top mounting member, the stock bearing could be mounted below the second bearing means. As shown in FIG. 5, the top mounting member 3c of the caster 1c has a top plate 27c with a circular step 91c extending down therefrom and a stub shaft 47c extending downwardly from the center of the step 91c. The bottom caster member 11c has a bottom plate 49c with a circular block 29c thereon. A bore 33c is provided in the block 29c extending downwardly from its top surface 97c. A counterbore 37c extends downwardly from the top surface 97c concentric about the bore 33c. A stock bearing 55c is press-fit mounted within the bore 33c about the stub shaft 47c. The bearing 55c is slightly higher than the depth of the bore 33c allowing load to be transferred from the top mounting member 3c to the bottom caster member 11c.

Second bearing means 67c are provided between the step 91c and th block 29c. The second bearing means 67c has an annular raceway 69c formed in two parts, one part being an annular groove 71c in step 91c and the other part being an annular groove 75c in the inner wall 73b forming the counterbore 37c. The grooves 71c, 75c are semi-circular when seen in cross-section. When the stub shaft 47c is inserted into the bore 33c, the step 91c fits snugly within the counterbore 37c and the grooves 71c, 75c align forming the raceway 69c. Loose bearing balls 85c are inserted into the raceway 69c through a passageway 79c in the block 29c. The second bearing means 67c facilitate rotation of the bottom caster member 11c relative to the top mounting member 3c and also serve to retain the stub shaft 47c within the bore 33c thereby connecting the two members 3c, 11c together.

1. A swivel caster having a top mounting member for attachment to the bottom of a vehicle; a bottom caster member having a caster wheel support extending downwardly therefrom with a caster wheel at the free end thereof; one of the top and bottom members having a stub shaft extending toward the other member, the other member having a circular bore for receiving the free end of the stub shaft and a counterbore concentric about the bore; a first bearing means comprising a stock bearing press fit mounted in one of the bore and the counterbore about the stub shaft, the first bearing means mounted to transfer load from the top member to the bottom member; and a second bearing means comprising a ring of loose balls mounted in an annular raceway, with part of the raceway formed in the circular wall defining the other of the bore and the counterbore, the second bearing means permitting rotation of the bottom member relative to the top member and retaining the stub shaft in the circular bore to connect the top and bottom members together.

2. A swivel caster as claimed in claim 1 wherein the bottom member has the stub shaft extending upwardly into the bore in the top member; the counterbore in the top member forming an annular chamber about the stub shaft with the stock bearing press fit mounted within the counterbore; the one part of the raceway formed in the wall of the bore and the other part of the raceway formed in the stub shaft.

3. A swivel caster as claimed in claim 1 wherein the bottom member has an upwardly extending circular pad, the stub shaft extending upwardly from the center of the pad; the pad mounted snugly in the counterbore, the bore forming an annular chamber about the stub shaft with the stock bearing press fit mounted within the bore; the one part of the raceway formed in the wall of the counterbore and the other part of the raceway formed in the pad.

4. A swivel caster as claimed in claim 1 wherein the top member has the stub shaft extending downwardly into the bore in the bottom member; the counterbore in the bottom member forming an annular chamber about the stub shaft with the stock bearing press fit mounted within the counterbore; the one part of the raceway formed in the bore and the other part of the raceway formed in the stub shaft.

5. A swivel caster as claimed in claim 1 wherein the top member has a downwardly extending circular pad, the stub shaft extending downwardly from the center of the pad; the pad mounted snugly in the counterbore, the bore forming an annular chamber about the stub shaft with the stock bearing press fit mounted within the bore; the one part of the raceway formed in the wall of the counterbore and the other part of the raceway formed in the stub shaft.

6. A swivel caster as claimed in claim 1 wherein the stock bearing is a thrust ball bearing.

7. A swivel caster as claimed in claim 2 wherein the stock bearing is a thrust ball bearing.

8. A swivel caster as claimed in claim 3 wherein the stock bearing is a thrust ball bearing.

9. A swivel caster as claimed in claim 4 wherein the stock bearing is a thrust ball bearing.

10. A swivel caster as claimed in claim 5 wherein the stock bearing is a thrust ball bearing.
